(19) United States
(12) Patent Application Publication
(10) Pub. No.: US 2004/0102880 A1
(43) Pub. Date: May 27, 2004

(54) System for monitoring vehicle wheel vibration

(76) Inventor: James K Brown, Winchester, TN (US)

Correspondence Address: Michael E Carmen, Dilworth & Barrese, 333 Earle Ovington Boulevard, Uniondale, NY, 11553, US

(21) Appl. No.: 10/399,730

(22) PCT Filed: Oct. 17, 2001
(86) PCT No.: PCT/US01/32365

(51) Int. Cl. G01M 17/013

(52) U.S. Cl. 701/29; 73/660; 73/579

(57) ABSTRACT

A system for monitoring vehicle wheel vibration is provided which includes at least a plurality of vibration sensors, each one monitoring a respective vehicle wheel for vibration. Tile system further includes a monitoring circuit to monitor each one of the vibration sensors for a sensed vibration signal, and an indicator panel to notify a vehicle operator of a vibration condition or problem. In an alternative embodiment, the system includes a communication module which transmits a vibration data signal through the vehicle's antenna by known communication technologies, e.g., cellular, satellite, etc. The communication module will transmit the vibration data signal either directly to the vehicle operator's cellular phone or to a central service station which will, in turn, contact the vehicle operator to indicate the vibration condition or problem.

### PRIORITY

This application claims priority to an application entitled “VEHICLE WHEEL VIBRATION MONITOR SYSTEM” filed in the United States Patent and Trademark Office on Oct. 20, 2000 and assigned Ser. No. 60/242,109, the contents of which are hereby incorporated by reference.

### BACKGROUND OF THE INVENTION

1. Field of the Invention

The present invention relates generally to a vibration monitoring system. More particularly, the present invention is directed to a system for monitoring vehicle wheels for vibration and providing an indication to a vehicle operator when a vibration-inducing condition exists.

2. Description of the Related Art

Improperly balanced wheels on a vehicle typically result in a variety of problems.

Such problems are, for example, premature tire wear and steering and suspension part wear. These problems ordinarily arise due to the inherent vibration from the bouncing action when wheels are out of balance. Also, when the vehicle wheels leave the surface of the road momentarily, additional wear on those areas of the tire that are in contact with the road will occur. The steering and suspension of the vehicle is also adversely affected, since additional wear and tear occurs in order to suppress the bouncing action. Consequently, vibration throughout the vehicle is dramatically increased.

While wheel imbalance is the most common cause of vibration, there are also other contributors. Tires may incur flat spots (due to sudden skids or a bubble between the inner belt and outer tread of the tire), heavy spots or tread separation. In addition, improperly mounted tires may cause a side-to-side wobbling to occur. In addition to causing irritating vibration within the vehicle, these conditions also adversely affect the ride and handling of the vehicle and increase driver fatigue.

Typically, tires are balanced when mounted and are rarely, if ever, checked for the aforementioned vibration-inducing conditions throughout the life of the tire. Prior art systems have been proposed to monitor vehicle wheel conditions and to alert the vehicle's operator if an abnormal condition arises. One such system is disclosed in U.S. Pat. No. 5,557,552 entitled “SYSTEM FOR PROJECTING VEHICLE SPEED AND TIRE CONDITION MONITORING SYSTEM USING SAME” issued to Toshiharu Naito et al. on Sep. 17, 1996 (hereinafter, the '552 patent). The '552 patent discloses a system for projecting an absolute speed of a vehicle comprising a first detecting means to detect an unsprung vibration frequency component acting on a front wheel, a second detecting means to detect an unsprung vibration frequency component on a rear wheel, a phase difference determining means to determine the difference between the front and rear components, and a vehicle speed projecting means to project the absolute speed of the vehicle based on the phase difference and a wheel base of the vehicle. The system of the '552 patent requires a toothed wheel mounted adjacent to each of the vehicle's wheels and a plurality of pickup coils each precisely aligned to its respective toothed wheel to provide an alternating sensor signal having a frequency indicative of a speed of each tire. The signals are then processed by complex calculations, including taking the Fourier transform of each signal, to calculate the absolute speed of the vehicle. Secondarily, the system performs further calculations to determine tire inflation pressure and wear condition of the tires.

While the system of the '552 patent may provide an accurate measurement of vehicle speed, it is a complex system requiring many hardware components to perform sophisticated calculations. The use of the toothed wheels and pick-up coils will make the system cost prohibitive to retrofit onto an existing vehicle, and the precise alignment of these components required during installation on a new vehicle will result in higher manufacturing costs.

Another prior art system for monitoring vehicle wheel conditions is disclosed in U.S. Pat. No. 6,266,586 entitled “VEHICLE WHEEL VIBRATION MONITORING SYSTEM” issued to Allain Gagnon on Jul. 24, 2001 (hereinafter, the '586 patent). The '586 patent discloses a vibration monitoring system, preferably for a truck, which includes a pair of pneumatic sensors mounted on the axles of the truck connected to a control box for disabling the truck. The control box is arranged to vent the air brake circuit of the truck for applying the brakes of the truck if the control box receives a vibration signal from the sensors. The '586 patent also contemplates using electronic sensors and an electronic control box that either controls the brakes or the throttle of the truck to slow or stop the vehicle's movement.

However, the system of the '586 patent has several drawbacks. First, the system has the potential for creating a dangerous situation where the system either stops or slows down the vehicle while it may possibly be in traffic. Second, the system's sensors are placed on the axles of the vehicle, and therefore, the system cannot determine without further investigation which exact wheel caused the vibration condition. Lastly, the indicating means of the system of the '586 patent only alerts the operator of the vehicle after the system begins to brake the vehicle which again may place the vehicle in a dangerous situation.

It would therefore be advantageous to have a system with a minimal amount of hardware resulting in simple processing that continually monitors the individual wheels of a vehicle for vibration-inducing conditions and provides an indication to a vehicle operator when such a wheel vibration condition exists.

### SUMMARY OF THE INVENTION

It is therefore an object of the present invention to provide a system for monitoring individual vehicle wheels for vibration.

It is another object of the present invention to provide a system to indicate to a vehicle operator when a vibration-inducing condition exists in any one or more of the vehicle wheels.

To achieve the above and other objects, a system for monitoring vehicle wheel vibration in accordance with the present invention includes at least a plurality of vibration sensors, each one monitoring a respective vehicle wheel for vibration. The system further includes a monitoring circuit to monitor each one of the vibration sensors for a sensed vibration signal, and an indicator panel to notify a vehicle operator of a vibration condition or problem.

In an alternative embodiment, the system for monitoring vehicle wheel vibration according to the present invention includes a communication module which transmits a vibration data signal through the vehicle's antenna by known communication technologies. The communication module will transmit the vibration data signal either directly to the vehicle owner's cellular phone or to a central service station which will, in turn, contact the operator to indicate the vibration condition or problem.

### BRIEF DESCRIPTION OF THE DRAWINGS

The above and other objects, features, and advantages of the present invention will become more apparent in light of the following detailed description of an exemplary embodiment thereof taken in conjunction with the attached drawings in which:

FIG. 1 is a block diagram illustrating one embodiment of a vibration monitoring system in accordance with the present invention;

FIG. 2 illustrates an exemplary indicator panel in accordance with the present invention;

FIG. 3 illustrates a preferred mounting location for the vibration sensors in accordance with the present invention;

FIG. 4 is a block diagram illustrating an alternative embodiment of a monitoring circuit for the vibration monitoring system in accordance with the present invention; and

FIG. 5 is a block diagram illustrating a second embodiment of the vibration monitoring system in accordance with the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail to avoid obscuring the invention in unnecessary detail. It is provided that identical elements are structurally and functionally equivalent throughout the drawings.

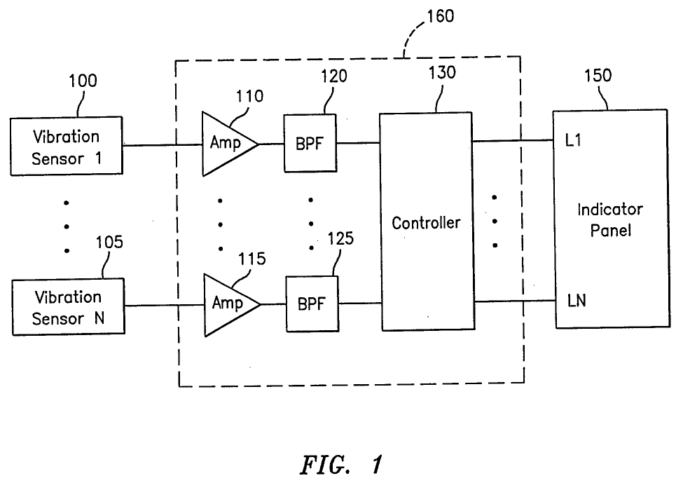

Referring to FIG. 1, an exemplary vehicle tire vibration monitoring system according to the present invention is illustrated. The system comprises at least one vibration sensor 100-105, a vibration monitoring circuit 160, and an indicator panel 150. The vibration monitoring circuit 160 includes at least one amplifier 110-115, at least one bandpass filter (BPF) 120-125, and a controller 130.

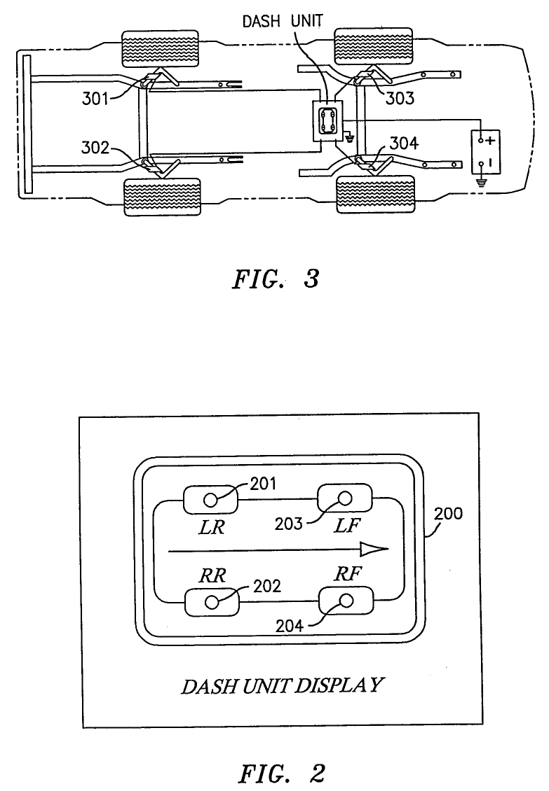

FIG. 2 illustrates an exemplary indicator panel 200 in accordance with the present invention. The indicator panel 200 includes at least a plurality of indicator lamps 201-204, such as LEDs (light emitting diodes), each corresponding to one of the wheels of the vehicle. When a vibration is detected in any one of the sensors 100-105, the monitoring circuit 160 controls the indicator panel 200 to illuminate the corresponding indicator lamp 201-204. Accordingly, a vehicle operator is notified of the problem, and specifically, notified of which wheel is causing the problem. The indicator panel 200 is preferably incorporated with the instrumentation panel of the vehicle.

FIG. 3 illustrates a preferred mounting location for the vibration sensors in accordance with the present invention. The vibration sensors 301-304, similar to sensors 100-105, are preferably on or near the non-rotating parts of the suspension that are near each respective wheel of the vehicle. As one skilled in the art will readily appreciate, the exact mounting location will vary from vehicle to vehicle. It is particularly advantageous to place the sensors 301-304 in a location that has minimal vibration due to normal driving conditions, yet is adequately close enough to the respective wheel to readily sense tire-induced vibrations. Once the ideal location is determined, each vibration sensor 301-304 is mounted using sensor mounting methods commonly known in the art. In a preferred embodiment, each vibration sensor is mounted using an adhesive such as, for example, quick setting viscous methyl cyanoacrylate adhesive (i.e., a 5-minute epoxy). Soft adhesives should not be used, since they may absorb vibration and adversely affect performance of the inventive system.

The vibration sensors 100-105 or 301-304 are preferably an accelerometer type, such as, for example, a piezo film type as manufactured by Measurement Specialties Incorporated (MSI) of Norristown, Pa. Other accelerometer type sensors that may be employed in the system of the present invention include piezoresistive type, strain gauge type and variable capacitance type. Moreover, vibration sensors of various types commonly used in the art may be used, such as those typically used to monitor industrial machinery for vibration. Examples of such vibration sensors include non-contacting displacement transducers, e.g. eddy current probes, and electrodynamic velocity transducers as manufactured by Wilcoxon Research of Gaithersburg, Md.

In operation, each vibration sensor 100-105 detects vibration emanating from the vehicle in the area it is monitoring and converts the vibration to a corresponding electrical signal. More particularly, vibration sensor 100 will be located on a non-rotating part of the vehicle's suspension located near the wheel which it is monitoring. When vibration is created by the respective wheel, due to a vibration-inducing condition, a corresponding electrical signal is produced within the respective vibration sensor. The corresponding electrical signal has a frequency characteristic which corresponds to the frequency of the vibration.

The signal is then amplified in amplifier 110 and filtered in BPF 120. Each vibration sensor 100-105 has a corresponding amplifier 110-115 and BPF 120-125. The amplifier 110 sets the signal magnitude at a desired level, as determined by the requirements of the controller 130. The BPF 120 passes only signals within a preferred frequency band. The preferred frequency band is ideally set to correspond to vibration induced from the vehicle wheels over a preferred angular velocity range of the tires. For example, a preferred angular velocity may be about 8-20 revolutions/second. Vibrations generated from a vehicle wheel having one of the vibration-inducing conditions will be within a corresponding frequency range, which will correspond to an electrical signal having a frequency within a given frequency band; the electrical signal being generated by the vibration sensor 100 and amplified by the amplifier 110. The BPF 120 is operational to reject all signals outside the given frequency band, and pass signals within the given frequency band to the controller 130.

The controller 130 monitors the signal lines of each BPF 120-125 to determine when a vibration-inducing condition is detected from the corresponding wheel. When a signal is passed by a BPF 120-125, the controller 130 sends a corresponding control signal L1-LN to the indicator panel 150 to illuminate the corresponding indicator lamp 201-205, and notify the operator of the vehicle.

In a preferred embodiment, the controller 130 includes timer circuitry. A signal is sent to the indicator panel 150 only when the signal from the corresponding BPF 120-125 is passed for a predetermined sampling period, such as about 2 seconds. Using this preferred method, the possibility of false readings due to road-induced vibrations is minimized. The controller 130, or indicator panel 150, also preferably includes latching capabilities to maintain an indication on the indicator panel 200, the indication being resetable from a button (not shown) on the indicator panel by the operator, to allow the operator to take multiple readings for verification purposes. Alternatively, the indication on the indicator panel 150 may only illuminate while the vibration-inducing condition exists.

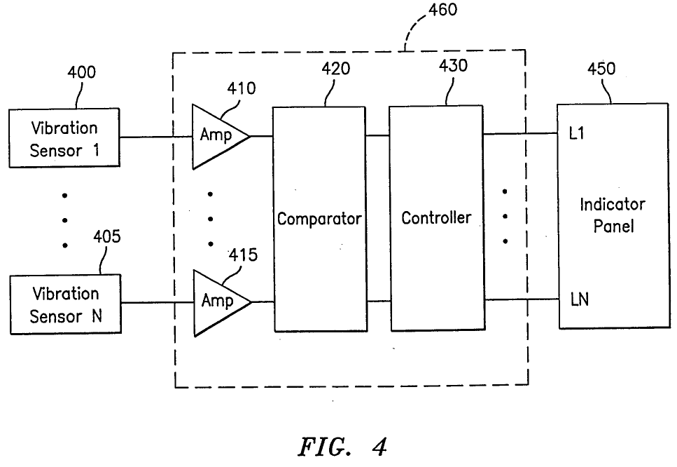

FIG. 4 illustrates the vehicle wheel vibration monitoring system having an alternative embodiment of a vibration monitoring circuit 460. In FIG. 4, the BPFs are replaced by a comparator circuit 420. The comparator circuit 420 continually monitors the signals received from the amplifiers 410-415 and performs a comparison between the signals. When the characteristics, i.e. frequency, of one signal is different from the rest by a predetermined margin, that signal is forwarded to the controller 430. The controller 430 then monitors the signal, preferably over a sampling period, and controls the indicator panel 450 as described above with respect to controller 130.

The monitoring circuit 460 of FIG. 4 has advantages in that it is more readily adaptable to a variety of vehicles and applications. The comparator configuration of FIG. 4 is less dependent on predetermined frequency ranges and sensor mounting locations, since the signals from the sensors 400-405 are simply compared.

The electronics for the vehicle wheel vibration monitoring system of all embodiments receive power from the vehicle electrical system (not shown) and may further include voltage regulators (not shown) as needed.

The controller 130/430 and/or comparator circuit 420 may be realized using common electrical devices known in the art. For example, the controller 130/430 may be a single integrated circuit (IC) package including programmable logic, analog-to-digital converters, and amplifiers. The controller 130/430 may include a software program and processor or may be entirely realized in hardware. Also, it will be understood by an ordinarily skilled artisan that the entire vibration monitoring circuit 160/460 may be realized on a single IC package.

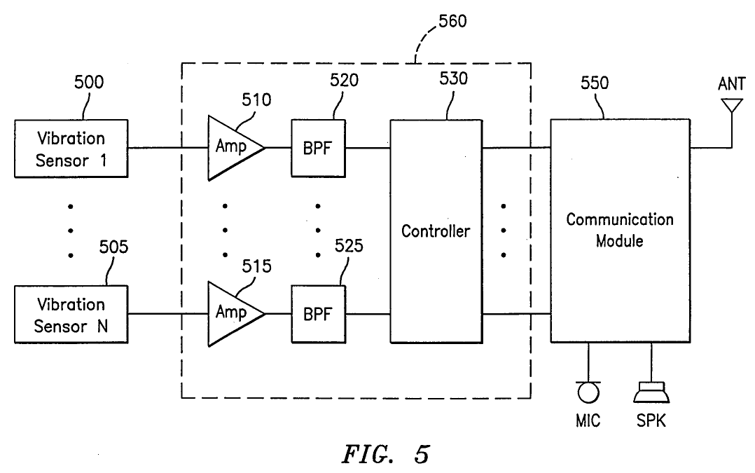

As an additional embodiment, it is contemplated that the system described above includes a communication module 550 as shown in FIG. 5, instead of or in addition to, the indicator panel 150/450. Upon detection of a potential vibration problem by receiving signals generated by the vibration sensors 500-505 via the amplifiers 510-515 and BPFs 520-525, the controller 530 of the system outputs a data signal to the communication module 550, which in turn transmits the data signal through the vehicle's antenna ANT by known communication technologies, e.g. cellular, satellite, etc. The data signal includes, but is not limited to, an ID number of the vehicle, the owner's name, the model of the vehicle, the specific wheel incurring the problem and the tire type.

Depending on how the system is programmed or configured, the operator of the vehicle can be alerted of the problem in several ways. In one scenario, upon detection of a problem, the communication module will dial a preprogrammed telephone number to alert the vehicle operator by the operator's own cellular phone. Alternatively, the communication module 550 may alert a predetermined central service station, e.g., a gas station or tire center. Upon receiving the data signal, the central service station will match the ID number of the vehicle with its database and, in turn, generate a maintenance work order for that particular vehicle. A representative of the central service station can then contact the operator through the communication module 550, which further includes a microphone MIC and speaker SPK for voice communications. The central service station representative can then inform the operator of the potential problem and schedule the operator to bring the vehicle in for maintenance or replacement of the wheel.

It is to be understood that the embodiment of the vehicle wheel vibration monitor system incorporating the communications module 550 can be employed with both embodiments of the monitoring circuits 160/460 as described above and shown in FIGS. 1 and 4.

As described above, the vehicle wheel vibration monitor system of the present invention will alert a vehicle operator of a vibration problem in a particular tire at an early stage to avoid potential vibration-induced repairs or accidents. For example, the early detection of a vibrating tire, and subsequent correction of the cause, will eliminate costly repairs that are caused by excessive vibration of suspension parts. In addition, early detection of a tread separation or bubble in the tire could avoid a potentially deadly accident.

While the present invention has been described in detail with reference to the preferred embodiments, they represent mere exemplary applications. Thus it is to be clearly understood that many variations can be made by anyone having ordinary skill in the art while staying within the spirit and scope of the present invention.

What is claimed is:

1. A system for monitoring vehicle wheel vibration comprising:
at least one vibration sensor for sensing vibration of a respective vehicle wheel, said at least one vibration sensor mounted on a non-rotating structural member of a vehicle's suspension;
a vibration monitoring circuit for processing a signal generated by said at least one vibration sensor; and
an indicator panel for indicating to a vehicle operator a vibration condition for the respective vehicle wheel.

2. The system as claimed in claim 1, wherein said vibration monitoring circuit comprises:
at least one amplifier for setting a magnitude of said signal at a predetermined level;
at least one bandpass filter for filtering said signal to ensure said signal is within a predetermined frequency band; and
a controller for monitoring said signal received from said bandpass filter to determine the vibration condition for the respective vehicle wheel.

3. The system as claimed in claim 2, wherein said controller further comprises timer circuitry for timing the duration of said signal received from the bandpass filter.

4. The system as claimed in claim 1, wherein said indicator panel comprises at least one indicator lamp corresponding to the respective vehicle wheel.

5. The system as claimed in claim 1, wherein said at least one vibration sensor is selected from the group consisting of an accelerometer type sensor, a non-contacting displacement transducer, and an electrodynamic velocity transducer.

6. The system as claimed in claim 1, wherein said vibration monitoring circuit comprises:
a plurality of amplifiers corresponding to a respective vibration sensor of the at least one vibration sensor for setting a magnitude of said signal generated by said respective vibration sensor at a predetermined level;
a comparator circuit for performing a comparison between two signals received from said plurality of amplifiers, said comparator circuit forwarding a single signal of said two signals determined to have different frequency characteristics from the other received signal; and
a controller for monitoring said single signal received from said comparator circuit to determine the vibration condition for the respective vehicle wheel.

7. The system as claimed in claim 6, wherein said controller further comprises timer circuitry for timing the duration of said single signal received from the comparator circuit.

8. A system for monitoring vehicle wheel vibration comprising:
at least one vibration sensor for sensing vibration of a respective vehicle wheel, said at least one vibration sensor mounted on a non-rotating structural member of a vehicle's suspension;
a vibration monitoring circuit for processing a signal generated by said at least one vibration sensor; and
a communication module for communicating a vibration condition for the respective vehicle wheel.

9. The system as claimed in claim 8, wherein said vibration monitoring circuit comprises:
at least one amplifier for setting a magnitude of said signal at a predetermined level;
at least one bandpass filter for filtering said signal to ensure said signal is within a predetermined frequency band; and
a controller for monitoring said signal received from said bandpass filter to determine the vibration condition for the respective vehicle wheel.

10. The system as claimed in claim 9, wherein said controller further comprises timer circuitry for timing the duration of said signal received from the bandpass filter.

11. The system as claimed in claim 8, wherein said at least one vibration sensor is selected from the group consisting of an accelerometer type sensor, a non-contacting displacement transducer, and an electrodynamic velocity transducer.

12. The system as claimed in claim 8, wherein said vibration monitoring circuit comprises:
a plurality of amplifiers corresponding to a respective vibration sensor of the at least one vibration sensor for setting a magnitude of said signal generated by said respective vibration sensor at a predetermined level;
a comparator circuit for performing a comparison between two signals received from said plurality of amplifiers, said comparator circuit forwarding a single signal of said two signals determined to have different frequency characteristics from the other received signal; and
a controller for monitoring said single signal received from said comparator circuit to determine the vibration condition for the respective vehicle wheel.

13. The system as claimed in claim 12, wherein said controller further comprises timer circuitry for timing the duration of said single signal received from the comparator circuit.

14. The system as claimed in claim 8, wherein said communication module further comprises an antenna for transmitting a signal communicating the vibration condition to a vehicle operator's mobile communication terminal.

15. The system as claimed in claim 8, wherein said communication module further comprises:
an antenna for transmitting a signal communicating the vibration condition to a central service station; and
a microphone and speaker for voice communications between a vehicle operator and said central service station.

16. A method for monitoring vehicle wheel vibration comprising the steps of:
providing at least one vibration sensor for sensing vibration of a respective vehicle wheel;
mounting said at least one vibration sensor on a non-rotating structural member of a vehicle's suspension;
monitoring a signal generated by said at least one vibration sensor; and
notifying a vehicle operator of a vibration condition for the respective vehicle wheel.

17. The method as claimed in claim 16, further comprising the steps of:
amplifying said signal to a magnitude of a predetermined level;
filtering said signal to ensure said signal is within a predetermined frequency band; and
monitoring said filtered signal to determine the vibration condition for the respective vehicle wheel.

18. The method as claimed in claim 17, wherein the step of monitoring said filtered signal includes the step of monitoring said filtered signal for a predetermined sampling period.

19. The method as claimed in claim 16, further comprising the steps of:
amplifying a plurality of signals corresponding to a respective vibration sensor of the at least one vibration sensor for setting a magnitude of said signal generated by said respective vibration sensor at a predetermined level;
performing a comparison between two amplified signals;
forwarding a single signal of said two signals determined to have different frequency characteristics from the other received signal; and
monitoring said single signal to determine the vibration condition for the respective vehicle wheel.

20. The method as claimed in claim 19, wherein the step of monitoring said single signal includes the step of monitoring said single signal for a predetermined sampling period.

21. The method as claimed in claim 16, wherein the step of notifying the vehicle operator of the vibration condition for the respective vehicle wheel further comprises the step of transmitting a signal indicating the vibration condition to a vehicle operator's mobile communication terminal.

22. The method as claimed in claim 16, wherein the step of notifying the vehicle operator of the vibration condition for the respective vehicle wheel further comprises the steps of:
transmitting a signal indicating the vibration condition to a central service station; and
broadcasting the vibration condition to the vehicle operator by the central service station.

23. A vehicle comprising a system for monitoring vehicle wheel vibration, wherein the system includes:
at least one vibration sensor for sensing vibration of a respective vehicle wheel, said at least one vibration sensor mounted on a non-rotating structural member of the vehicle's suspension;
a vibration monitoring circuit for processing a signal generated by said at least one vibration sensor; and
an indicator panel for indicating to a vehicle operator a vibration condition for the respective vehicle wheel.

24. The vehicle as claimed in claim 23, wherein said vibration monitoring circuit comprises:
at least one amplifier for setting a magnitude of said signal at a predetermined level;
at least one bandpass filter for filtering said signal to ensure said signal is within a predetermined frequency band; and
a controller for monitoring said signal received from said bandpass filter to determine the vibration condition for the respective vehicle wheel.

25. The vehicle as claimed in claim 24, wherein said controller further comprises timer circuitry for timing the duration of said signal received from the bandpass filter.

26. The vehicle as claimed in claim 23, wherein said indicator panel comprises at least one indicator lamp corresponding to the respective vehicle wheel.

27. The vehicle as claimed in claim 23, wherein said at least one vibration sensor is selected from the group consisting of an accelerometer type sensor, a non-contacting displacement transducer, and an electrodynamic velocity transducer.

28. The vehicle as claimed in claim 23, wherein said vibration monitoring circuit comprises:
a plurality of amplifiers corresponding to a respective vibration sensor of the at least one vibration sensor for setting a magnitude of said signal generated by said respective vibration sensor at a predetermined level;
a comparator circuit for performing a comparison between two signals received from said plurality of amplifiers, said comparator circuit forwarding a single signal of said two signals determined to have different frequency characteristics from the other received signal; and
a controller for monitoring said single signal received from said comparator circuit to determine the vibration condition for the respective vehicle wheel.

29. The vehicle as claimed in claim 28, wherein said controller further comprises timer circuitry for timing the duration of said single signal received from the comparator circuit.

30. A vehicle comprising a system for monitoring vehicle wheel vibration, wherein the system includes:
at least one vibration sensor for sensing vibration of a respective vehicle wheel, said at least one vibration sensor mounted on a non-rotating structural member of the vehicle's suspension;
a vibration monitoring circuit for processing a signal generated by said at least one vibration sensor; and
a communication module for communicating a vibration condition for the respective vehicle wheel.

31. The vehicle as claimed in claim 30, wherein said vibration monitoring circuit comprises:
at least one amplifier for setting a magnitude of said signal at a predetermined level;
at least one bandpass filter for filtering said signal to ensure said signal is within a predetermined frequency band; and
a controller for monitoring said signal received from said bandpass filter to determine the vibration condition for the respective vehicle wheel.

32. The vehicle as claimed in claim 31, wherein said controller further comprises timer circuitry for timing the duration of said signal received from the bandpass filter.

33. The vehicle as claimed in claim 30, wherein said at least one vibration sensor is selected from the group consisting of an accelerometer type sensor, a non-contacting displacement transducer, and an electrodynamic velocity transducer.

34. The vehicle as claimed in claim 30, wherein said vibration monitoring circuit comprises:
a plurality of amplifiers corresponding to a respective vibration sensor of the at least one vibration sensor for setting a magnitude of said signal generated by said respective vibration sensor at a predetermined level;
a comparator circuit for performing a comparison between two signals received from said plurality of amplifiers, said comparator circuit forwarding a single signal of said two signals determined to have different frequency characteristics from the other received signal; and
a controller for monitoring said single signal received from said comparator circuit to determine the vibration condition for the respective vehicle wheel.

35. The vehicle as claimed in claim 34, wherein said controller further comprises timer circuitry for timing the duration of said single signal received from the comparator circuit.

36. The vehicle as claimed in claim 30, wherein said communication module further comprises an antenna for transmitting a signal communicating the vibration condition to a vehicle operator's mobile communication terminal.

37. The vehicle as claimed in claim 30, wherein said communication module further comprises:
an antenna for transmitting a signal communicating the vibration condition to a central service station; and
a microphone and speaker for voice communications between a vehicle operator and said central service station.
